(19) United States
(12) Patent Application Publication
(10) Pub. No.: US 2002/0187693 A1
(43) Pub. Date: Dec. 12, 2002

(54) Method and apparatus to increase wind uplift resistance in roofing membranes

(76) Inventor: David J. Cherry, Dallas, TX (US)

Correspondence Address: Thomas C. Wright, GARDERE WYNNE SEWELL LLP, 1601 Elm Street, Suite 3000, Dallas, TX, 75201, US

(21) Appl. No.: 09/840,476

(22) Filed: Apr. 23, 2001

(51) Int. Cl. D04B 1/00; D04C 1/00; D04G 1/00; D03D 9/00; D03D 19/00; D04B 21/00; B32B 5/26; B32B 25/02; B32B 25/10; B32B 27/04; B32B 27/12; B32B 27/32; B32B 5/02; B61D 17/12; B61D 39/00; B32B 11/02; B32B 11/10

(52) U.S. Cl. 442/32; 442/37; 442/38; 442/40; 442/41; 442/43; 52/45; 442/48

(57) ABSTRACT

The present invention provides roofing membrane that increases wind resistance by having at least a two sheets of scrim material (10) that is between an upper layer (12) and a lower layer (14). The upper and lower layers (12 and 14) may be a thermoplastic or other material appropriate for use in a roofing membrane.

### FIELD OF THE INVENTION

The present invention relates generally to the field of roofing membranes and specifically to a laminated roofing membrane that imparts added wind resistance when the membrane is attached to a roof.

### BACKGROUND OF THE INVENTION

To effectively resist damaging winds, all roofing membranes must be securely anchored to the underlying decking. This is particularly true of roofing membranes attached to relatively low-sloped roofs, where the lifting action associated with the Bernoulli effect in high winds is great.

Building codes in the United States generally require a roofing system to withstand a 90 mile-per-hour wind in order to be certified. Factory Mutual Research Corporation (FMR) has developed a test for measuring and certifying the uplift resistance of a roofing membrane. The method of attachment and the materials that make up the roofing membrane have a great effect on the uplift resistance as measured by the FMR test.

Typically, single ply roofing membranes are mechanically attached using an “overlap method.” This involves using a metal fastener, such as a screw or bolt, which pierces the membrane and the underlying decking. The point of attachment is then overlapped with the edge of an adjacent piece of roofing membrane, and the edge of the overlapping material is bonded to the first piece of membrane material.

Applying roofing by this method is labor intensive. It is time consuming to place the necessary number of attachment devices, such as nails, screws, bolts, or other hardware. A large number of attachment sites are typically necessary in order to achieve a sufficiently high wind uplift resistance. Any process or material that allows for the use of fewer attachment sites would be a great benefit. An alternative economic advantage would result from a system that uses a comparable number of attachments to the present systems, but that uses less expensive materials to achieve the same or similar wind uplift resistance.

The overlap method of applying a roofing membrane is effective but suffers from some shortcoming when the roofing system is exposed to high winds. When a high wind load is placed on the roofing material, there is a great deal of stress at the point where the attaching hardware is placed through the membrane, and the membrane will fail. Additionally, the bonding between the two sheets of membrane is subjected to strain and the sheets tend to pull apart.

Other roofing methods modify the basic “overlap” approach. These include the use of flaps built into the membrane to cover the attachment sites, however, these offer no additional strength and do not increase the wind uplift resistance of the membrane when it is attached to the roof deck.

Accordingly, there is a need for a roofing membrane that has increased wind resistance, but that does not add disproportionately to the cost of the materials or to the labor costs associated with its installation.

### SUMMARY OF THE INVENTION

The present invention provides a roofing membrane that provides increased wind resistance by having at least a two sheets of scrim material that are between an upper layer and a lower layer. The upper and lower layers may be a thermoplastic or other material appropriate for use in a roofing membrane.

In another form of the invention the roofing membrane has an upper layer and a lower layer, and two side edges. The membrane includes a layer of scrim, made up of at least a two sheets of scrim material, aligned with the first or second side edges.

Yet another form of the present invention is a method for making a roofing membrane made up of the steps of feeding a layer of scrim, which is composed of at least two sheets of scrim material, into a calendaring apparatus. While in the calendaring apparatus the scrim layer is combined with a first polymer resin to form an upper layer and a second polymer resin to form a lower layer. The calendaring apparatus laminates the upper, lower and scrim layers together to form a single ply material.

Still another form of the present invention is a method for making a roofing membrane made up of the steps of feeding a scrim layer, that has a first and a second side edge and two ends, and includes a first sheet and a second sheet of scrim material substantially aligned with the first and second side edges. The second sheet of scrim material does not cover the entire first scrim sheet.

Another form of the present invention is a system of attaching a laminated roofing membrane that has an upper layer and a lower layer and two or more sheets of scrim material between the upper and lower layers. The roofing membrane is attached to the roof using attachment hardware that includes, but is not limited to, nails, screws and bolts. The attachment hardware attaches the membrane to the roof deck at a site on the membrane where the scrim layer is made up of at least two layers of scrim material. The site of attachment may be along a single side edge of the roofing membrane or along both side edges. A second adjacent membrane may be overlapped with the first. The overlapping portion of the second roofing membrane may be adhesively sealed to the first or the two layers of membrane may be heat-welded together.

Another embodiment of the present invention would include a laminated roofing membrane made up of an upper layer and a lower layer that are above and below respectively a layer of scrim that is made of one or more first sheets of scrim material that cover the entire area of the membrane and at least one second sheet of scrim material that is substantially aligned with at least one side edge of the membrane. Also aligned substantially along at least one side edge and attached to the upper layer of the roofing membrane is a flap of material that covers at least a portion of the membrane that contains the second scrim sheet.

### BRIEF DESCRIPTION OF THE DRAWINGS

The above and further advantages of the invention may be better understood by referring to the following detailed description in conjunction with the accompanying drawings in which corresponding numerals in the different figures refer to the corresponding parts in which:

FIG. 1 depicts a view of a roofing membrane in accordance with one embodiment of the present invention;

FIG. 2 depicts an apparatus for preparing a roofing membrane consistent with the present invention;

FIG. 3 depicts a two-piece mold for use in preparing materials in accordance with the present invention; and

FIG. 4 depicts a testing apparatus for measuring the tensile strength of materials consistent with the present invention.

### DETAILED DESCRIPTION OF THE INVENTION

While the making and using of various embodiments of the present invention are discussed herein in terms of a roofing membrane and a method for using it, it should be appreciated that the present invention provides many applicable inventive concepts that can be embodied in a wide variety of specific contexts. The specific embodiments discussed herein are merely illustrative of specific ways to make and use the invention and are not meant to limit the scope of the invention in any manner.

The present invention provides a roofing membrane and method that is simple and yet improves the wind resistance of a roof that incorporates the material. As a result the present invention allows roofing manufacturers to design both stronger roofs and roofs that incorporate more economical raw materials. The added strength of the roofing membranes of the present invention allows a reduction in the amount of labor required to mount the membrane to a roof deck, since fewer attachment sites are required to achieve an acceptable wind uplift resistance.

The general features of the present roofing membrane are two outer layers of material appropriate for use in a roofing membrane that are laminated together around a layer of scrim material. Those familiar with this field will appreciate that the outer layers can be composed of any a variety of thermoplastic, thermoset, polymeric, or bituminous materials. Examples include, but are not limited to, ethylene propylene diene monomer (EPDM), polyvinyl chloride (PVC), and thermoplastic olefinic elastomer (TPO). TPO includes those compounds in the definition of TPO provided by the ASTM, _and also EPR, EPDM rubber and other appropriate rubbers or polymers or mixtures thereof in combination with polypropylene, polyethylene, any suitable alpha-olefin and copolymers thereof as well as mixtures of any of the above referenced compounds including the addition of flame retardants and other additives.

The scrim material is typically made of polyester, but can be fiberglass, cotton or any of a range of reinforcing materials familiar to those skilled in the art. The scrim material may be any fibrous, oriented or unoriented, material that imparts added strength to a roofing membrane. An individual component of a scrim layer is referred to in this application as a sheet. In some cases a sheet is not continuous across the entire width of the membrane, but is made up of one or more pieces of scrim material.

One feature of the present invention is the inclusion of additional reinforcing scrim in the scrim layer. Traditionally roofing membranes have only incorporated a single sheet of scrim. The present invention further reinforces the roofing membrane by adding at least a portion of an additional sheet of scrim, especially in the area where the membrane will be attached to the roof. This added reinforcement provides increased wind-uplift resistance by reducing the tendency of the membrane to fail at the points of attachment.

While the present invention includes adding additional scrim material, all of the sheets of scrim material that makeup the scrim layer need not be in direct contact with one another. The scrim sheets may be separated by any material, thermoplastic or otherwise, that would facilitate their incorporation into a roofing membrane.

The Factory Mutual Research Corporation Uplift Pressure Test for Class 1 Roof Covers is designed to quantify and certify the wind resistance of roofing materials. The testing apparatus consists of a pressure apparatus that delivers a predetermined air pressure to the underside of a roof assembly test panel. The materials to be tested are assembled and allowed to cure for a specified time period, if desired. The panel containing the test sample is placed on top of the pressure apparatus and air pressure is applied.

In order to be considered a Factory Mutual Class 1 Roof Cover the assembly must withstand the effects of 60 pounds of pressure per square foot (Class 1-60 Windstorm Classification) or 90 pounds of pressure per square foot (Class 1-90 Windstorm Classification) for a period of one minute. During the test period the roofing material is observed for bowing, cracking, delamination, and separation of attachment hardware.

In one embodiment the present invention incorporates the additional sheets of scrim near the edge of the membrane where it will be secured to the roof deck. The width of the additional scrim can be of any width, including the entire width of the membrane, but is typically from 2 to 18 inches in width and aligned with one or both of the outside edges of the roofing membrane. Attachment hardware may be used on one or both side edges of the membrane.

For the purposes of this application the perimeter of the membrane is defined as follows: the membrane has two end edges and two side edges. The side edges are defined as the two opposite edges of the membrane that are attached to roof deck or overlapped with an adjacent sheet of membrane. The attachment to the roof deck is accomplished with attachment hardware, which is defined as any fastener that connects the roofing membrane to the roof deck. The attachment hardware may be, but is not limited to, nails, bolts and screws.

In one embodiment of the present invention it is possible to attach the membrane with attachment hardware on one side and heat-weld, glue, or tape the opposite side edge to the adjacent layer of membrane. This is the traditional “overlap” method.

In another embodiment it is also possible to attach the membrane with attachment hardware on both of the side edges. In yet another embodiment flaps of additional upper layer material are attached to the upper layer substantially aligned with one or both side edges to cover the sites of attachment when the membrane is attached to a roof deck.

Another embodiment of the present invention is a method of producing a roofing membrane that includes the steps of feeding a scrim layer, made up of two or more sheets of scrim material, into a calendaring apparatus. While in the apparatus the scrim is combined with polymer resins that form the upper and lower layers of the membrane. The calendaring apparatus laminates the upper and lower layers together with the scrim layer to form a single ply material. In the present application, the term “calendaring apparatus” means any device with two or more rollers that presses, with or without heating, materials that are fed into it into a single ply material.

It is also possible to form the thermoplastic material that makes up the upper and lower layer separately, e.g. through the use of a Banbury, and to then laminate the thermoplastic material to the scrim material using a calendaring operation. The lamination of the scrim material with the thermoplastics that make up the upper and lower layers of the roofing membrane may be done at the same time, or as separate operations.

An alternative method of forming a membrane of the present invention is to contact the additional scrim material with the face of either the upper or lower surface. The face is defined as the exposed surface of the membrane.

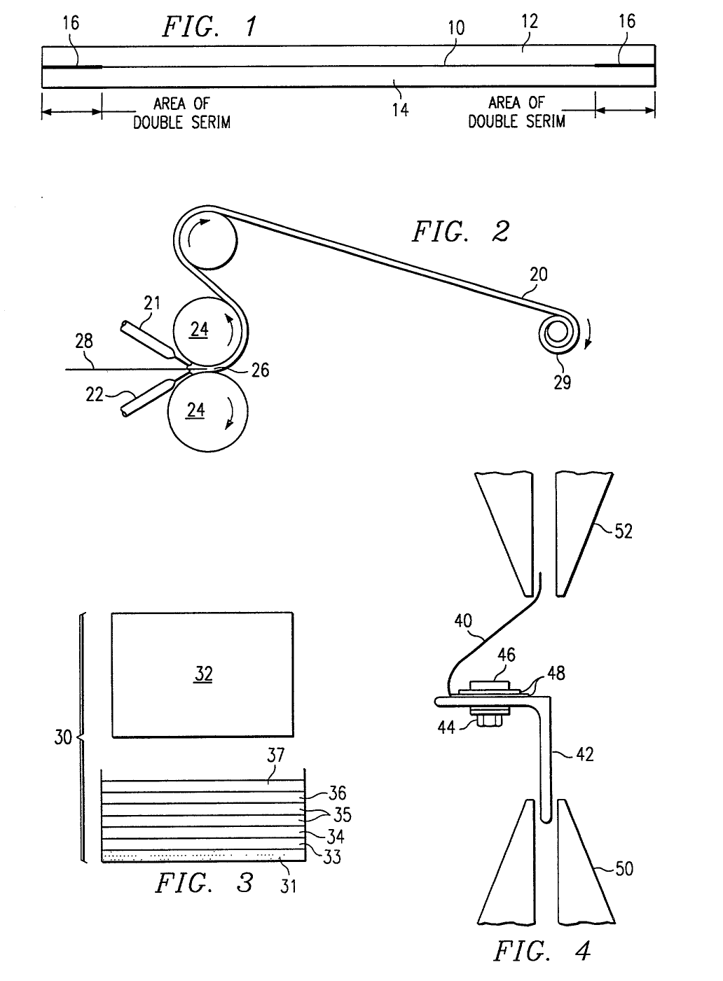

FIG. 1 depicts one embodiment of the present invention. The scrim layer 10 is shown laminated between an upper layer 12 and a lower layer 14. The layers are typically made of thermoplastic, but can include other polymer, rubber, or rubberized materials. The upper layer is also typically augmented by the addition of additives to stabilize the membrane to the sunlight (ultraviolet light) and other atmospheric conditions to which it may be exposed. The area of the roofing membrane where the additional sheeting of scrim is added is shown as areas 16. The additional scrim sheeting may also be place on the outer surface of either the upper 12 or lower 14 surfaces, or both, in an area corresponding to area 16.

FIG. 2 depicts a method for forming a roofing membrane 20 in accordance with the present invention that utilizes an extruding device to calendar the resins that make up the upper and lower layers together with the scrim layer to form the roofing membrane 20. Two extruders (not shown) feed molten resin through the separate sheet dies 20 and 21 to the chilled rollers 24. At the nip 26 where the chilled rollers 24 pinch the incoming material, the scrim layer 28 is fed between the molten extrudates and the entire structure is cooled and wound into a roll 29. The scrim layer 28 has already been configured when fed into the nip. The scrim layer may consist of two or more full sheets of scrim material that are the full width of the membrane being produced.

In another embodiment of the present invention, the scrim layer 28 may consist of one or more full width sheets of scrim material and one or more additional sheets or strips of scrim material that are substantially aligned with one or both of the side edges of the full width sheet.

In still another embodiment one may form the additional sheets of scrim that are aligned with the side edges by folding over a portion of the full width sheet along the side edges. In this embodiment the total width of the scrim sheet before folding for feeding into the calendaring apparatus would be the width of the membrane to be produced plus the width of the scrim material that is to be folded back over to produce the double thickness. For the purposes of this application the folded-back portion of the scrim material is considered a second sheet of scrim material.

### EXAMPLES

The following materials were used in the preparation and testing of roofing membranes in accordance with one embodiment of the present invention.

The upper layer was prepared from pellets of UVTEC thermoplastic FR 7061 blended with Catalloy KS 358 (Basell) in a 58%:42% weight ratio. This material was extruded into a sheet approximately 20 mils thick using a 1.5 inch extruder with a 38:1 L/D. The L/D is the ratio of the length of the barrel of the extruder to the diameter of the extruder screw. The lower layer was prepared similarly using pellets of UVTEC FR 7060 Gray blended with Catalloy KS 358 material in a 8%:92% weight ratio. The resulting extruded sheet was also about 20 mils thick. The scrim material was commercially available polyester webbing.

Three samples were prepared using a two-piece 4-inch compression mold 30 depicted in FIG. 3 consisting of a cavity portion 31 and a top 32. The cavity portion 31 of the mold was approximately 48 mils deep. Layers were stacked in the mold 30 in the following order: a 4 mil mylar sheet 33 to facilitate removal, a layer of the lower layer material 34 prepared as described above, two layers of the scrim material 35 described above, a layer of top material 36, prepared as described above, followed by another mylar layer 37 to facilitate removal from the mold 30.

The top 32 was placed on the cavity portion of the mold 31 and the assembled mold was placed in a heated Model M Carver Laboratory Press at 400 psi. The platens of the press were heated to 400° F. for five minutes. The platens are the plates that distribute the force of the press to the mold. The heating was discontinued and the platens were slowly cooled with water to below 200° F. At this point the mold 30 was immersed in water to complete the cooling and was opened when cool to the touch.

The samples were removed from the cavity 31 and the mylar film 33 and 37 was removed from both side. The samples were allowed to condition at room temperature for 24 hours.

The samples were tested for puncture resistance as shown in FIG. 4. The sample to be tested 40 was attached to an L-bracket 42 using a nut 44, bolt 46 and washers 48.

The L-bracket 44 was secured to the bottom jaws 50 of a Tinius Olsen 1000 Tensile Tester (not pictured). The sample 40 was secured to the top jaws 52 of the Tester, and the Tester was run. Testing was performed at 4 inches per minute and the ultimate force recorded.

The results for three samples are shown in Table 1. A comparison of the average tear strength of samples containing a double sheet of scrim material with those containing a single sheet is shown in Table 2.

TABLE 1

| | Tear Strength |
|---|---|
| Sample | (Lbs.) |
| 1 | 178 |
| 2 | 178 |
| 3 | 181 |

TABLE 2

| Average Tear Strength-Two | Average Tear Strength-One |
|---|---|
| Scrim Sheets | Scrim Sheet |
| 179 Lbs. | 132.5 Lbs. |

Although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims that follow.

What is claimed:

1. A roofing membrane comprising:
an upper layer, a lower layer and a scrim layer between the upper and lower layers, wherein the membrane also has two end edges and a first and a second side edges, and the upper and lower layers each have a face.

2. The roofing membrane recited in claim 1, wherein the scrim layer further comprises at least a first sheet and a second sheet of scrim material.

3. The roofing membrane recited in claim 2, wherein the second sheet of scrim material contacts the face of either the upper or lower surface, or both.

4. The roofing membrane recited in claim 2, wherein the second sheet of scrim material does not completely contact the first sheet of scrim material.

5. The roofing membrane recited in claim 1, wherein the scrim layer further comprises at least a first sheet and a second sheet of scrim material, wherein the second sheet is substantially aligned with the first or second side edges.

6. The roofing membrane recited in claim 1, wherein the membrane is a single ply.

7. The roofing membrane recited in claim 2, wherein the second sheet of scrim material is substantially aligned with both the first and the second side edge.

8. The roofing membrane recited in claim 2, wherein the width of the second sheet is from about 2 inches to about 18 inches.

9. The roofing membrane recited in claim 1, wherein one or more of the layers further comprises a thermoplastic material.

10. The roofing membrane recited in claim 1, wherein one or more of the layers further comprises thermoplastic olefinic elastomer (TPO).

11. The roofing membrane recited in claim 1, wherein one or more of the layers further comprises polyvinylchloride (PVC).

12. The roofing membrane recited in claim 1, wherein one or more of the layers further comprises ethylene propylene diene monomer (EPDM).

13. The roofing membrane recited in claim 1, wherein one or more of the layers further comprises a bituminous material.

14. The roofing membrane recited in claim 1, wherein one or more of the layers comprises a rubber material.

15. The roofing membrane recited in claim 1, wherein one or more of the layers further comprises one or more additives.

16. The roofing membrane recited in claim 13, wherein the additives comprise stabilizers.

17. The roofing membrane recited in claim 15, wherein the additives comprise stabilizers that protect the membrane from ultraviolet light.

18. The roofing membrane recited in claim 1, wherein the scrim layer comprises a polyester material.

19. The roofing membrane recited in claim 1, wherein the scrim layer comprises a fiberglass material.

20. The roofing membrane recited in claim 2, wherein the upper layer further comprises a flap associated with one or both side edges, wherein the flap covers a portion of the membrane where it contains a second sheet of scrim material.

21. A roofing membrane comprised of a single layer having an upper and a lower surface, with one or more sheets of scrim material contacting the upper or lower surface or both surfaces.

22. A method for making a roofing membrane comprising the steps:
feeding a scrim layer that comprises one or more first sheets and one or more second sheets of scrim material into a calendaring apparatus,
combining the scrim layer with an upper layer material comprising a first polymer resin;
combining the scrim layer with a lower layer material comprising a second polymer resin;
calendaring the scrim layer and the upper and lower layers to laminate the layers together to produce a laminate with two side edges.

23. The method recited in claim 22, wherein the first and second polymer resins are thermoplastic resins.

24. The method recited in claim 22, wherein the first and second thermoplastic resins comprise the same resin.

25. The method recited in claim 22, wherein the scrim material comprises a fiberglass material.

26. The method recited in claim 22, wherein the scrim material comprises a polyester material.

27. The method recited in claim 22, wherein the second sheet of scrim material is substantially aligned with one side edge of the membrane, and does not cover the entire first sheet.

29. The method recited in claim 22, further comprising the step of attaching a flap to the upper layer such that it covers a portion of the membrane that contains the second sheet of scrim material.

30. A system for attaching a laminated roofing membrane comprising the steps:
Contacting a laminated roofing membrane comprising an upper layer and a lower layer with a scrim layer in between the upper and lower layers, and having two side edges, wherein the scrim layer further comprises one or more first sheets and one or more second sheets of scrim material, with a surface;
Piercing the laminated roofing membrane through the upper, lower and scrim layers with attachment hardware.

31. The system recited in claim 30, wherein the second sheet of scrim material does not cover the entire first sheet of scrim material, and is substantially aligned with one side edge of the membrane; and
The piercing comprises piercing the upper layer, the lower layer and the first and second scrim sheets with attachment hardware.

32. The system recited in claim 30, wherein the piercing pierces the upper layer, the lower layer and the first scrim sheet in the vicinity of the second scrim sheet.

33. The system recited in claim 30, wherein the second sheet of scrim material does not cover the entire first sheet of scrim material, and is substantially aligned with both side edge of the membrane; and
The piercing comprises piercing the upper layer, the lower layer, and the first and second scrim sheets on both side edges with attachment hardware.

34. The system recited in claim 30, further comprising:
overlapping one or both side edges of the membrane with an adjacent membrane to form a seam; and
sealing the seam.

35. The system recited in claim 34, wherein the sealing comprises adhesively sealing the seam.

36. The system recited in claim 34, wherein the sealing comprises heat welding the seam.

37. The system recited in claim 30, wherein the upper layer of the membrane further comprises a flap that covers a portion of the membrane that contains the second sheet of scrim material.
